(19) United States
(12) Patent Application Publication
(10) Pub. No.: US 2002/0072585 A1
(43) Pub. Date: Jun. 13, 2002

(54) PPE derivatives and resin composition having the same

(75) Inventors: Chingchen S. Chiu, Taoyuan Hsien (TW); Chien-Ting Lin, Hsinchu (TW); Gue-Wuu Hwang, Kaohsiung (TW); Li-Chung Liang, Hsinchu Hsien (TW); Meng-Song Yin, Hsinchu (TW)

Correspondence Address: DARBY & DARBY P.C., 805 Third Avenue, New York, NY, 10022, US

(73) Assignee: Industrial Technology Research Institute

(21) Appl. No.: 09/751,567

(22) Filed: Dec. 28, 2000

(30) Foreign Application Priority Data
Oct. 17, 2000 (TW) 89121681

(51) Int. Cl. C08G 65/38; C08G 65/40; C08G 65/42

(52) U.S. Cl. 528/489; 528/86; 428/425.1; 428/479.6

(57) ABSTRACT

This invention relates to a partially or exhaustively derivatized PPE. The partially derivatized PPE comprises vinylated phenylene ether repeating unit, and at least one another repeating unit, which is selected from a phenylene ether repeating unit and a hydroxylated phenylene ether repeating unit. A resin composition having a low curing temperature is also disclosed, which comprises: (a) a partially or exhaustively derivatized PPE; and (b) a free radical initiator.

### BACKGROUND OF THE INVENTION

1. Field of the Invention

The present invention relates to polyphenylene ether (PPE) derivatives. Particularly, the present invention relates to PPE derivatives with low curing temperature and their resin compositions as well.

2. Description of the Related Art

The majority of copper clad laminate (CCL) currently employed in the printed circuit board (PCB) is epoxy FR-4. The electric performance of epoxy laminate in the high frequency region cannot meet the future needs in wireless communication, satellite equipment and broadband applications. A laminate with better dielectric constant (Dₖ) and dissipation factor (D_{f}) is thus needed for high speed and high frequency technologies.

PPE as a thermoplastic resin, however, is very poor in heat and solvent resistance. These shortcomings must be solved before PPE can be seriously considered as a material for laminate application. And, the most intriguing way to solve these shortcomings is by transferring the thermoplastic PPE to thermosetting PPE.

Such transformation has been made as indicated in European Patent No. 382312. This patent discloses that the —CH₃ side group on PPE was first lithiated by n-butyllithium (n-BuLi) and then reacted with allyl halide (CH₂═CHCH₂X; X=Cl, Br, I) to form —CH₂CH₂CH═CH₂. Hence a thermosetting PPE is obtained (hereafter referred to as APPE).

It also shows that the curing reactions of APPE, peroxide and triallyl isocyanurate (TAIC) could be effected only at high temperatures, 250° C. or higher. This temperature range is too high for the common laminating process in industry. Thus, it is necessary to lower the laminating temperature to under 200° C. before a thermosetting PPE can be practically used as a laminate material.

### SUMMARY OF THE INVENTION

Therefore, an object of the present invention is to solve the above-mentioned problems and to provide a method of transferring the original thermoplastic PPE to thermosetting PPE derivatives with better heat and solvent resistance for the laminate application.

Another object of the present invention is to provide thermosetting PPE derivatives with curing temperatures lower than 200° C. This temperature capability is just adequate to the common industrial laminating process.

A further object of the present invention is to provide a resin composition comprising the low temperature self-crosslinkable PPE derivatives as materials for laminate.

To achieve the above objects, the present invention provides thermosetting PPE derivatives with the following formula (I) or (II)

[chemical structure]

wherein R can be the same or different and each R independent denotes a hydrogen atom or a C₁-C₃ alkyl group; R′ and R″ can be hydrogen, C₁-C₈ ether, C₁-C₈ amine, C₁-C₈ amide or C₁-C₈ ester; A can be C₁-C₈ ether, C₁-C₈ amine, C₁-C₈ amide or C₁-C₈ ester; n denote the number 1 or 2; m denotes 0 or an integer from 1 to 6; x=0.01, y=0-0.98, z=0-0.98 and x+y+z=1. The arrangements of phenylene moieties with subscript letters x, y and z can be in random or block fashion.

According to the present invention, the PPE derivatives can be PPE with N,N-diallyl acetamide group (hereafter referred to as ANOPPE), PPE with allyl ether group (hereafter referred to as AOPPE) or PPE withallyl acetate group (hereafter referred to as AEPPE).

These thermosetting PPE derivatives are prepared by hydroxylation and Williamson-type synthesis. In the hydroxylation step, the PPE is allowed to react with Lewis acid, such as AlCl₃, SbCl₅ or SnCl₄, and hydrogen peroxide to produce hydroxyl group on the phenylene ring. The subsequent Williamson-type synthesis involves a strong base, a quaternary ammonium salt and appropriate reactants, in order to introduce vinyl groups into the hydroxylated PPE. The strong base can be alkaline metal hydroxide, alkaline metal hydride or alkaline-earth metal hydride, such as LiOH, NaOH, KOH, NaH or CaH₂. The quaternary ammonium salt can be (n-Bu)₄NHSO₄, (n-Bu)₄NOH, (n-Bu)₄NBr, (n-Bu)₄NI, (n-Pr)₄NHSO₄ or (n-Pr)₄NI. The Williamson-type reactants in this invention are molecules with carbon-carbon double bond and a good leaving group for the nucleophilic substitution reaction. The leaving groups can be chloride, bromide, iodide, p-toluenesulfonate or methanesulfonate. Representative examples of the Williamson-type reactants according to the invention are allyl-halo-acetamide, allyl-halo-amine, allyl-halo-acetate, allyl halide and pentene sulfonate. Preferred examples include allyl bromide, N,N-diallyl chloroacetamide, allyl chloroacetate and 4-pentenyl p-toluenesulfonate.

Since these thermosetting PPE derivatives are self-crosslinkable, the present invention also provides a composition comprising: (a) the thermosetting PPE derivative of formula (I) or (II); and (b) a free radical initiator.

Any suitable free radical initiator may be used. Preferred free radical initiators include 2,5-dimethyl-2,5-di-tert-butylperoxy-hexane (DHBP), di-tert-butylperoxide (DTBP), di-cumylperoxide (DCP), benzoylperoxide (BPO), 1,3-di(2-tert-butylperoxy isopropyl) benzene (DIPP) and 2,5-dimethyl-2,5-di-tert-butylperoxy-hexyne (DYBP).

The thermosetting PPE resin compositions of the present invention may further include a hardener in 0.5-65 parts by weight of resin. Representative examples of the hardener include triallyl isocyanurate (TATC) and triallyl cyanurate (TAC) . The resin composition can also comprise a flame retardant, such a$ phosphorous-, chlorine-, bromine-, nitrogen-containing flame retardant or antimony oxide, in 0.5-50 parts by weight of resin.

These resin compositions can be used as the dielectric materials in the preparation of prepreg, laminate or copper clad laminate. The dielectric consists of the resin composition reinforced with fibers. The most commonly used fiber materials are paper and E-glass. The fibers can be either chopped (usually paper) or woven into a fabric.

The present invention also provides a functionalizable PPE derivative with the following formula:

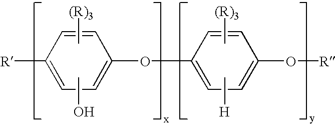

wherein R can be the same or different and each R independently denotes a hydrogen atom or a C₁-C₃ alkyl group; R′ and R″ can be hydrogen, C₁-C₈ ether, C₁-C₈ amine, C₁-C₈ amide or C₁-C₈ ester; x=0.01-1, y=0-0.99 and x+y=1. The arrangements of phenylene moieties with subscript letters x and y can be in random or block fashion.

According to the present invention, this functionalizable PPE is produced by reacting the thermoplastic PPE with Lewis acid and hydrogen peroxide. The Lewis acid is AlCl₃, SbCl₅ or SnCl₄.

### DETAILED DESCRIPTION OF THE PRESENT INVENTION

### Thermosetting PPE Derivative

Thermosetting PPE derivatives are produced in the present invention. According to the present invention, the thermosetting PPE resins are PPE derivatives of formula (I) or

[chemical structure]

wherein R can be the same or different and each R independently denotes a hydrogen atom or a C₁-C₃ alkyl group; R′ and R″ can be hydrogen, C₁-C₈ ether, C₁-C₈ amine, C₁-C₈ amide or C₁-C₈ ester; A can be C₁-C₈ ether, C₁-C₈ amine, C₁-C₈ amide or C₁-C₈ ester; n denotes the number 1 or 2; m denotes 0 or an integer from 1 to 6; x=0.01-1, y=0-0.98, z=0-0.98 and x+y+z=1. The arrangements of phenylene moieties with subscript letters x, y and z can be in random or block fashion. A PPE is called exhaustively derivatized when x=1and partially derivatized when x<1.

### Preparation of the PRE Derivatives

The thermosetting PPE resins are prepared by steps comprising hydroxylation and Williamson-type synthesis. In the hydroxylation step, the thermoplastic PPE is allowed to react with Lewis acid and hydrogen peroxide to produce hydroxyl group on the phenylene ring. Either an exhaustively or a partially hydroxylated PPE derivative can be obtained by carefully experimental design and execution. The subsequent Williamson-type synthesis involves a strong base, a quaternary ammonium salt and appropriate reactants, in order to introduce vinyl groups into the hydroxylated PPE. The reaction steps are illustrated as follows:

[chemical structure]

The Lewis acid can be AlCl₃, SbCl₅ or SnCl₄. The strong bases include alkaline metal hydroxide, alkaline metal hydride and alkaline-earth metal hydride. Representative examples of strong base are LiOH, NaOH, KOH, NaH or CaH₂. The quaternary ammonium salt can be (n-Bu)₄NHSO₄, (n-Bu)₄NOH, (n-Bu)₄NBr, (n-Bu)₄NI, (n-Pr)₄NHSO₄ or (n-Pr)₄NI. Preferred examples of the Williamson-type reactants according to the invention are allyl bromide, N,N-diallyl chloroacetamide, allyl chloroacetate and 4-pentenyl p-toluenesulfonate. R, R′, R″, A, n, m, x, y, and z are defined as above.

### Resin Compositions

According to the present invention, the thermosetting PPE resin compositions with adequate curing temperature comprises (a) the thermosetting PPE derivative of formula (I) or (II); and (b) a free radical initiator.

The free radical initiators may include 2,5-dimethyl-2,5-di-tert-butylperoxy-hexane (DHBP), di-tert-butylperoxide (DTBP), di-cumylperoxide (DCP), benzoylperoxide (BPO), 1,3-di(2-tert-butylperoxy isopropyl) benzene (DIPP), 2,5-dimethyl-2,5-di-tert-butylperoxy-hexyne (DYBP) and chemicals in that nature. The initiator in the compositions is in the range of 0.5-8 parts by weight of resin.

According to the present invention, the thermosetting resin compositions can further comprise a hardener in 0.5-65 parts by weight of resin. Preferred examples of the hardeners include triallyl isocyanurate (TAIC) and triallyl cyanurate (TAC). The resin composition can also comprise a flame retardant, such as phosphorous-, chlorine-, bromine-containing flame retardant or antimony oxide, in 0.5-50 parts by weight of resin.

### Application of the Resin Compositions in Laminate

These resin compositions of the present invention can be used as the dielectric materials in the preparation of prepreg. The dielectric consists of the resin composition reinforced with fibers. First, one resin composition and appropriate solvent are completely mixed to make a varnish. Then, fibers are coated with such varnish and heated in a treater to give prepreg. The most commonly used fiber materials are paper and E-glass. Fibers can be either chopped (usually paper) or woven into a fabric. The dielectric constant (Dₖ) of thus made laminate with the thermosetting PPE derivatives of the present invention is at 3.0-3.6 for the frequency of 1 GHz.

### Application of the Resin Compositions in Copper Clad Laminate

A copper clad laminate is manufactured by pressing the laminate together with copper foil in an optimized temperature profile. The printed circuit boards made of the thermosetting PPE resin compositions of the present invention show desirable electric properties for high speed and high frequency technologies.

Without any intention of limiting itself in any way, the present invention is illustrated further by the following examples.

### EXAMPLE 1

### Preparation of Redisitributed PPE

A solution of 300 g of PPE with an average number molecular weight of 20,000 in 360 g of toluene in a round-bottom flask was added 54 g of 4,4′-isopropylidenediphenol (bisphenol A) with stirring at 100° C. After complete dissolution, a 72 g of 75% benzoylperoxide water solution was slowly introduced to the reaction mixture. The reaction mixture was then stirred for 2 hrs at 100° C. and cooled down to room temperature. 800 ml of methanol was added to the reaction mixture to precipitate the redistributed PPE. The precipitate was filtered. The filtrate was washed twice with 800 ml of methanol and vacuumed to dryness. 360 g of the redistributed PPE was obtained. By GPC measurement, the number average molecular weight of 2,500 of redistributed PPE was determined.

### EXAMPLE 2

### Preparation of APPE

A solution of 50 g of PPE in 500 ml of anhydrous tetrahydrofuran (THP) under the atmosphere of nitrogen in a round-bottom flask was drop by drop added a 80 ml of 1.6 M n-butyllithium hexane solution with stirring at 40° C. The reaction mixture was then added 20 ml of allyl chloride and an additional 200 ml of anhydrous THF. After 2 hrs of stirring at 40° C., the reaction mixture was allowed to cool down to room temperature and water was added to the mixture to quench the reaction. Layers were separated and the organic layer was washed with saturated brine solution as well as DI water. After concentration, a precipitate was formed in 200 ml of methanol. The precipitate was filtered and washed twice with 200 ml of methanol. 50 g of APPE was obtained after vacuum.

### EXAMPLE 3

### Hydroxylation of PPE

A solution of 50 g of the redistributed PPE obtained from example 1 in 450 ml of THF in a round-bottom flask was slowly added 170 g of AlCl₃ with stirring at room temperature. The reaction mixture was then added an additional 50 ml of THF and drop by drop introduced a 55 ml of 35% hydrogen peroxide water solution. Care should be exercised for this exothermic reaction. The reaction mixture was then stirred for 10 hrs at room temperature and cooled down to 0° C. in an ice-water bath. A 1M of HCl solution was, added to the reaction mixture to quench the reaction. Layers were separated and the organic layer was washed with saturated brine solution as well as DI water. After concentrations a precipitate was formed in 200 ml of methanol. The precipitate was filtered and washed twice with 200 ml of methanol. 45 g of hydroxylated PPE was obtained after vacuum. By NMR calculation, 60 hydroxyl groups were generated in every 100 phenylene units.

### EXAMPLE 4

### Preparation of AOPPE

A solution of 25 g of the hydroxylated PPE from Example 3 in 200 ml of CH₂Cl₂ in a round-bottom flask was added an 88.2 g of 50 wt % NaOH solution. After 10 minutes of stirring at room temperature, the reaction mixture was then added 6.2 g of (n-Bu)₄NHSO₄ and 32 ml of allyl bromide. The reaction mixture was then stirred for 10 hrs at room temperature and added 20 ml of water. Layers were separated and the organic layer was washed with saturated brine solution as well as DI water. After concentration, a precipitate was formed in 200 ml of methanol. The precipitate was filtered and washed twice with 200 ml of methanol. 25 g of AOPPE was obtained after vacuum.

### EXAMPLE 5

### Preparation of ANOPPE

A solution of 25 g of the hydroxylated PPE from Example 3 in 200 ml of CH₂Cl₂ in a round-bottom flask was added an 88.3 g of 50 wt % NaOH solution. After 10 minutes of stirring at room temperature, the reaction mixture was then added 6.2 g of (n-Bu)₄NHSO₄ and 60.2 g, of N,N-diallyl chloroacetamide. The reaction mixture was then stirred for 10 hrs at room temperature and added 20 ml of water. Layers were separated and the organic layer was washed with saturated brine solution as well as DI water. After concentration, a precipitate was formed in 200 ml of methanol. The precipitate was filtered and washed twice with 200 ml of methanol. 26 g of ANOPPE was obtained after vacuum.

### EXAMPLE 6

### Preparation of AEPPE

A solution of 25 g of the hydroxylated PPE from Example 3 in 200 ml of CH₂Cl₂ in a round-bottom flask was added an 88.2 g of 50 wt % NaOH solution. After 10 minutes of stirring at room temperature, the reaction mixture was then added 6.2 g of (n-Bu)₄NHSO₄ and 40 ml of allyl chloroacetate. The reaction mixture was stirred for 11 hrs at room temperature and added 20 ml of water. Layers were separated and the organic layer was washed with saturated brine solution as well as DI water. After concentration, a precipitate was formed in 200 ml of methanol. The precipitate was filtered and washed twice with 200 ml of methanol. 26 g of AEPPE was obtained after vacuum.

### Preparation of PPE Resin Composition and Measurements

### EXAMPLE 7

A solution of 67 g of ANOPPE fromExample 5 in 20 g of toluene in a round-bottom flask was added 33 g of TAIC and 3 g of DHBP at room temperature. The mixture was stirred thoroughly and stripped off solvent by vacuum. The residual mixture was pressed at 200° C. for 1 hr to give a sample sheet for measurements. The dissipation factor (D_{f}) and dieclectric constant (Dₖ) of the sample were measured by a dielectric analyzer, the glass transition temperature (T_{g}) was measured by a dynamic mechanical analyzer (DMA), and the curing temperature was measured by a rheometer. The results of these measurements are tabulated in Table 1.

### EXAMPLE 8

A solution of 80 g of ANOPPE from Example 5 in 50 g of toluene in a round-bottom flask was added 20 g of TAIC and 3 g of DHBP at room temperature. The mixture was stirred thoroughly and stripped off solvent by vacuum. The residual mixture was pressed at 200° C. for 1 hr to give a sample sheet for measurements. The dissipation factor (D_{f}) and dieclectric constant (Dₖ) of the sample were measured by a dielectric analyzer, the glass transition temperature (T_{g}) was measured by a dynamic mechanical analyzer (DMA), and the curing temperature was measured by a rheometer. The results of these measurements are tabulated in Table 1.

### EXAMPLE 9

A solution of 67 g of AOPPE from Example 4 in 50 g of toluene in a round-bottom flask was added 33 g of TAC and 3 g of DHBP at room temperature. The mixture was stirred thoroughly and stripped off solvent by vacuum. The residual mixture was pressed at 200° C. for 1 hr to give a sample sheet for measurements. The dissipation factor (D_{f}) and dielectric constant (Dₖ) of the sample were measured by a dielectric analyzer, the glass transition temperature (T_{g}) was measured by a dynamic mechanical analyzer (DMA), and the curing temperature was measured by a rheometer. The results of these measurements are tabulated in Table 1.

### EXAMPLE 10

A solution of 100 g of ANOPPE from Example 5 in 50 g of toluene in a round-bottom flask was added 3 g of DHBP at room temperature. The mixture was stirred thoroughly and stripped off solvent by vacuum. The residual mixture was pressed at 200° C. for 1 hr to give a sample sheet for measurements. The dissipation factor (D_{f}) and dielectric constant (Dₖ) of the sample were measured by a dielectric analyzer, the glass transition temperature (T_{g}) was measured by a dynamic mechanical analyzer (DMA), and the curing temperature was measured by a rheometer. The results of these measurements are tabulated in Table 1.

### Comparative Example 1

A solution of 80 g of APPE from Example 2 in 50 g of toluene in a round-bottom flask was added 20 g of TAIC and 3 g of DHBP at room temperature. The mixture was stirred thoroughly and stripped off solvent by vacuum. The curing temperature of the residual mixture was determined to be 250° C. by a rheometer.

TABLE 1
the curing temperature of resin compositions and
their physical properties after cured

| | | | | | Free | | Curing | | | |
|---|---|---|---|---|---|---|---|---|---|---|
| | PPE | | | | radical | | tempera- | Properties of the cured | | |
| | derivative | | Hardener | | initiator | | ture | resin | | |
| | Type | wt % | type | wt % | type | wt % | (° C.) | D_{f} | Dₖ (1 GHz) | T_{q} (° C.) |
| Example 7 | ANOPPE | 67 | TAIC | 33 | DHBP | 3 | 155 | 0.01 | 2.85 | 231 |
| Example 8 | ANOPPE | 80 | TAIC | 20 | DHBP | 3 | 155 | 0.01 | 2.80 | 231 |
| Example 9 | AOPPE | 67 | TAC | 33 | DHBP | 3 | 170 | 0.01 | 2.80 | 222 |
| Example 10 | ANOPPE | 100 | — | — | DHBP | 3 | 180 | 0.008 | 2.7 | 186 |
| Comparative | APPE | 80 | TAIC | 20 | DHBP | 3 | 250 | — | — | — |
| Example 1 | | | | | | | | | | |

TAIC: triallyl isocyanurate, TAC: triallyl cyanurate
DHBP: 2 ,5-dimethyl-2,5-di-tert-butylperoxy-hexane
ANOPPE: PPE with N,N-diallyl acetamide groups, x = 0.188, y = 0.409, z = 0.403
AOPPE: PPE with allyl ether groups, x = 0.241, y = 0.492, z = 0.267
AEPPE: PPE with allyl acetate groups, x = 0.023, y = 0.580, z = 0.397
APPE: PPE with (CH₂)₂—CH═CH₂ side-chain

### Preparation of Laminate

### EXAMPLE 11

A solution of 67 g of ANOPPE from Example 5 in 20 g of toluene in a round-bottom flask was added 33 g of TAIC and 3 g of DHBP at room temperature. the mixture was thoroughly stirred at room temperature to make a varnish. A 10 cm×10 cm of E-glass cloth was dipped in this varnish and then heated in a 120° C. treater to give a prepreg. The resin content of the prepreg was controlled at 57%. An 8-ply stack of prepreg was then pressed at 200° C. for 1 hr to give a laminate. The dissipation factor (D_{f}) and the dielectric constant (Dₖ) of the laminate were determined by a dielectric analyzer to be 0.01 and 3.3, respectively The glass transition temperature (T_{g}) was measured to be 227° C.

As shown in Table 1, the thermosetting PPE derivatives provided by the present invention have high glass transition temperature (T_{g}) and good electric properties in terms of dissipation factor (D_{f}) and dielectric constant (Dₖ). It is important to note that the curing temperatures of all these derivatives are well below 200° C. This temperature capability is adequately compatible with the common FR-4 laminating process.

While the present invention is described by illustrative examples and preferred embodiments, it should be understood that the invention is not limited to these examples and embodiments in any way. On the contrary, it is intended to cover all the modifications and arrangements as they would be apparent to those skilled in the art. Therefore, the scope of the appended claims should be interpreted in the broadest sense so as to encompass all the modifications and arrangements.

What is claimed is:

1. A PPE derivative represented by the following formula (I) or (II) [chemical structure]
wherein
R are the same or different and each R is independently selected from the group consisting of hydrogen and C₁-C₃ alkyl;
R′ and R″ are selected from the group consisting of hydrogen, C₁-C₈ ether, C₁-C₈ amine, C₁-C₈ amide and C₁-C₈ ester;
A is selected from the group consisting of C₁-C₈ ether, C₁-C₈ amine, C₁-C₈ amide and C₁-C₈ ester;
n is 1 or 2;
m is 0 or an integer of from 1 to 6; and
x=0.01˜1, y=0˜0.98, z=0˜0.98, x+y+z=1, and the arrangements of phenylene moieties with subscript letters x, y and z are in random or block fashion.

2. The PPE derivative as claimed in claim 1, which has dially acetamide group, allyl ether group or allyl acetate group.

3. A process for preparing a PPE derivative represented by the following formula (I) or (II), comprising the steps of: [chemical structure]
(a) hydroxylating a PPE to form a hydroxylated PPE; and
(b) introducing vinyl groups into the hydroxylated PPE, wherein
R are the same or different and each R is independently selected from the group consisting of hydrogen and C₁-C₃ alkyl;
R′ and R″ are selected from the group consisting of hydrogen, C₁-C₈ ether, C₁-C₈ amine, C₁-C₈ amide and C₁-C₈ ester;
A is selected from the group consisting of C₁-C₈ ether, C₁-C₈ amine, C₁-C₈ amide and C₁-C₈ ester;
n is 1 or 2;
m is 0 or an integer of from 1 to 6; and
x=0.01˜1, y=0˜0.98, z=0˜0.98, x+y+z=1, and the arrangements of phenylene moieties with subscript letters x, y and z are in random or block fashion.

4. The process as claimed in claim 3, wherein the step (a) comprises reacting a Lewis acid and a hydrogen peroxide with the PPE.

5. The process as claimed in claim 4, wherein the Lewis acid is selected from the group consisting of AlCl₃, SbCl₅ and SnCl₄.

6. The process as claimed in claim 3, wherein the step (b) comprises adding a strong base, a quaternary ammonium salt, and a compound having carbon-carbon double bond and leaving group.

7. The process as claimed in claim 6, wherein the strong base is selected from the group consisting of alkaline metal hydroxide, alkaline metal hydride, and alkaline-earth metal hydride.

8. The process as claimed in claim 7, wherein the alkaline metal hydroxide is selected from the group consisting of LiOH, NaOH and KOH.

9. The process as claimed in claim 6, wherein the C3-C4 quaternary ammonium salt is selected from the group consisting of (n-Bu)₄NHSO₄, (n-Bu)₄NOH, (n-Bu)₄NBr, (n-Bu)₄NI, (n-C₃H₇)₄NHSO₄, and (n-C₃H₇)₄NI.

10. The process as claimed in claim 6, wherein the leaving group is selected from the group consisting of halogen and sulfonate.

11. The process as claimed in claim 6, wherein the compound with carbon-carbon double bond and leaving group is selected from the group consisting of allyl-halo-acetamide, allyl-halo-amine, allyl-halo-acetate, allyl halide and pentene sulfonate.

12. The process as claimed in claim 6, wherein the compound with carbon-carbon double bond and leaving group is a compound with allyl group and halogen leaving group.

13. The process as claimed in claim 12, wherein the compound is selected from the group consisting of allyl-bromide, N,N-diallyl-chloroacetamide, and allyl-chloroacetate.

14. A resin composition, comprising:
(a) a PPE derivative represented by the following formula (I) or (II) [chemical structure]
wherein
R are the same or different and each R is independently selected from the group consisting of hydrogen and C₁-C₈ alkyl;
R′ and R″ are selected from the group consisting of hydrogen, C₁-C₈ ether, C₁-C₈ amine, C₁-C₈ amide and C₁-C₈ ester;
A is selected from the group consisting of C₁-C₈ ether, C₁-C₈ amine, C₁-C₈ amide and C₁-C₈ ester;
n is 1 or 2;
m is 0 or an integer of from 1 to 6; and
x=0.01˜1, y=0˜0.98 , z=0˜0.98, x+y+z=1, and the arrangements of phenylene moieties with subscript letters x, y and z are in random or block fashion;
(b) are radical initiator, which is present in an amount of from 0.5 to 8% by weight of the PPE derivative.

15. The resin composition as claimed in claim 14, wherein the free radical initiator is selected from the group consisting of 2,5-dimethyl-2,5-di-tert-butylperoxy-hexane (DHBP), di-tert-butylperoxide (DTBP), di-cumylperoxide (DCP), benzoylperoxide (BPO), 1,3-di(2- tert-butylperoxy isopropyl) benzene (DIPP) and 2,5-dimethyl-2,5-di-tert-butylperoxy-hexyne (DYSP).

16. The resin composition as claimed in claim 14, further comprising a hardener, which is present in an amount of from 0.5 to 65% by weight of the PPE derivative.

17. The resin composition as claimed in claim 16, wherein the hardener is selected from the group consisting of triallyl isocyanurate (TAIC) and triallyl cyanurate (TAC).

18. The resin composition as claimed in claim 14, further comprising a flame retardant, which is present in an amount of from 0.5 to 50% by weight of the PPE derivative.

19. The resin composition as claimed in claim 18, wherein the flame retardant is selected from the group consisting of phosphorous-, chlorine-, bromine-, nitrogen-containing flame retardant, and antimony oxide.

20. A prepreg, comprising:
(a) the resin composition as set forth in claim 14; and
(b) a reinforced material, used to impregnate the resin composition.

21. The prepreg as claimed in claim 20, wherein the reinforced material is paper or glass.

22. A copper clad laminate, comprising:
(a) the prepreg as claimed in claim 20; and
(b) a copper foil, laminated with the prepreg.

23. A functionalizable PPE derivative represented by the following formula 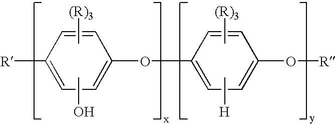
wherein
R are the same or different and each R is independently selected from the group consisting of hydrogen and C₁-C₃ alkyl;
R′ and R″ are selected from the group consisting of hydrogen, C₁-C₈ ether, C₁-C₈ amine, C₁-C₈ amide and C₁-C₈ ester; and
X=0.01˜1, y=0˜0.99, x+y=1, and the arrangements of phenylene moieties with subscript letters x and y are in random or block fashion.

24. The functionalizable PPE derivative as claimed in claim 23, which is produced by reacting a Lewis acid and a hydrogen peroxide with a PPE.

25. The functionalizable PPE derivative as claimed in claim 23, wherein the Lewis acid is selected from the group consisting of AlCl₃, SbCl₅ and SnCl₄.
